(19) United States
(12) Patent Application Publication
(10) Pub. No.: US 2024/0408756 A1
(43) Pub. Date: Dec. 12, 2024

(54) SYSTEMS AND METHODS FOR SPATIAL REPRESENTATIONS FOR NAVIGATION WITHOUT RECONSTRUCTION

(71) Applicant: Naver Corporation, Gyeonggi-do (KR)

(72) Inventors: Guillaume BONO, Crolles (FR); Leonid Antsfeld, Saint Ismier (FR); Gianluca Monaci, Grenoble (FR); Assem Sadek, Grenoble (FR); Christian Wolf, Fontaines Saint Martin (FR)

(73) Assignee: Naver Corporation, Gyeonggi-do (KR)

(21) Appl. No.: 18/634,457

(22) Filed: Apr. 12, 2024

Related U.S. Application Data
(60) Provisional application No. 63/471,342, filed on Jun. 6, 2023.

(51) Int. Cl. B25J 9/16; G01S 17/89; G06T 7/20

(52) U.S. Cl. CPC B25J 9/1666; B25J 9/1697; G01S 17/89; G06T 7/20; G06T 2207/20081; G06T 2207/20084

(57) ABSTRACT

A learning system for a navigating robot includes: a navigation module including: a first policy configured to determine actions for moving the navigating robot and navigating from a starting location to an ending location based on images from a camera of the navigating robot; and a second policy configured to, based on a representation of an environment generated by the navigating robot, determine actions for moving the navigating robot from waypoint locations between the starting location and the ending location to a plurality of subgoal locations without any images from the camera; and a representation module configured to: selectively learn the representation during movement via the first policy based on the representation at previous times, images from the camera, and actions determined by the first policy at previous times; and provide the representation to the second policy.

### CROSS-REFERENCE TO RELATED APPLICATIONS

This application claims the benefit of U.S. Provisional Application No. 63/471,342 filed on Jun. 6, 2023. The entire disclosure of the application referenced above is incorporated herein by reference.

### FIELD

The present disclosure relates to navigating robots and vehicles and more particularly to systems and methods for locating and navigating spaces.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Navigating robots are mobile robots that may be trained to navigate environments without colliding with objects during travel. Navigating robots may be trained in the environment in which they will operate or trained to operate regardless of environment.

Navigating robots may be used in various different industries. One example of a navigating robot is a package handler robot that navigates an indoor space (e.g., a warehouse) to move one or more packages to a destination location. Another example of a navigating robot is an autonomous vehicle that navigates an outdoor space (e.g., roadways) to move one or more occupants from a pickup to a destination.

### SUMMARY

In a feature, a learning system for a navigating robot includes: a navigation module including: a first policy configured to determine actions for moving the navigating robot and navigating from a starting location to an ending location based on images from a camera of the navigating robot; and a second policy configured to, based on a representation of an environment generated by the navigating robot, determine actions for moving the navigating robot from waypoint locations between the starting location and the ending location to a plurality of subgoal locations without any images from the camera; and a representation module configured to: selectively learn the representation during movement via the first policy based on the representation at previous times, images from the camera, and actions determined by the first policy at previous times; and provide the representation to the second policy.

In a feature, a learning system for an autonomous vehicle is described and includes: a navigation module comprising: a first policy configured to determine first actions for navigating the autonomous vehicle from a starting location to an ending location in a scene based on a latent representation of the scene; and a training module comprising: a second policy configured to determine second actions for navigating the autonomous vehicle from waypoint locations between the starting location and the ending location to a plurality of subgoal locations; the second policy determining the second actions without using as input sensory observations of the scene, including any images of the scene, except the plurality of subgoal locations and the latent representation of the scene computed by the first policy; in determining the second actions, the second policy producing a loss; and a representation module configured to: generate, as input to the first and second policies, the latent representation of the scene from images of the scene; backpropagate the loss of the second actions, for integrating into the latent representation of the scene obstacles to avoid that are visible in the scene between each subgoal location of each waypoint location learned by the second policy; in backpropagating the loss, the first policy learning to avoid obstacles it detects in the latent representation of the scene when the navigation module determines inference actions.

In further features, the representation module is configured to selectively learn the representation during the movement via the first policy using a neural network.

In further features, the neural network includes a recurrent neural network.

In further features, the recurrent neural network includes one of gated recurrent unit (GRU) memory and long-short term memory (LSTM).

In further features, the neural network includes one or more self-attention mechanisms.

In further features, the first policy is configured to determine an action at a time based on the representation at the time and a goal vector at that time.

In further features, the goal vector is a Euclidean goal vector.

In further features, the plurality of subgoal locations include at least two subgoal locations from each of the waypoint locations.

In further features, each of the at least two subgoal locations of a waypoint location are within a predetermined distance range of that waypoint location.

In further features, the predetermined distance range is approximately 3 meters to approximately 5 meters.

In further features, the second policy is configured to determine the actions for moving the navigating robot from waypoint locations between the starting location and the ending location to the plurality of subgoal locations without any images from the camera based on a recurrent neural network.

In further features, the second policy is configured to set the recurrent GRU memory using a GRU update function based on the representation, a previous instance of the recurrent GRU memory, and previous actions from the second policy.

In further features, a training module is configured jointly train the second policy and the neural network using behavior cloning.

In further features, the training module is configured to jointly train the second policy and a neural network of the first policy based on minimizing an error between (a) actions predicted by the first policy during movement and (b) ground truth actions for moving.

In further features, the training module is configured to jointly train the second policy and the neural network using a cross entropy loss.

In further features, the second policy is configured to initialize the representation upon reaching one of the waypoint locations.

In further features, the second policy is configured to receive the representation at each time step during navigation from one of the waypoint locations to one of the subgoal locations.

In further features, a training module is configured to train the first policy using one of reinforcement learning and imitation learning.

In a feature, a learning system for a navigating robot includes: a navigation module comprising: a first policy configured to determine actions for moving the navigating robot and navigating from a starting location to an ending location based on input from a light detection and ranging (LIDAR) sensor of the navigating robot; and a second policy configured to, based on a representation of an environment generated by the navigating robot, determine actions for moving the navigating robot from waypoint locations between the starting location and the ending location to a plurality of subgoal locations without input from the LIDAR sensor; and a representation module configured to: selectively learn the representation during movement via the first policy based on the representation at previous times, input from the LIDAR sensor, and actions determined by the first policy at previous times; and provide the representation to the second policy.

In a feature, a navigating robot includes: a camera; a navigation module including: (i) a first policy configured to determine actions for moving the navigating robot and navigating from a starting location to an ending location based on images from the camera; and (ii) a second policy configured to, based on a representation of an environment generated by the navigating robot, determine actions for moving the navigating robot from waypoint locations between the starting location and the ending location to a plurality of subgoal locations without any images from the camera; a representation module configured to: (i) selectively learn the representation during movement via the first policy based on the representation at previous times, images from the camera, and actions determined by the first policy at previous times; and (ii) provide the representation to the second policy; and one or more propulsion devices configured to implement the actions determined by the navigation module and propel the robot from the starting location and the ending location and from the waypoint locations.

In a feature, an autonomous vehicle for navigating a scene includes: (a) a camera for acquiring images of the scene; (b) a representation module for generating a latent representation of the scene from images of the scene; (c) a navigation module comprising a first policy configured to determine inference actions for navigating the autonomous vehicle in the scene from an inference starting location to an inference ending location based on the latent representation of the scene; and (d) one or more propulsion devices configured to implement the inference actions determined by the navigation module and propel the autonomous vehicle from the inference starting location to the inference ending location; wherein the first policy is trained by: (i) the navigation module that uses the first policy to determine first training actions for navigating the autonomous vehicle from a training starting location to a training ending location based on a latent representation of a training scene received from a representation module generated from images of the training scene; (ii) a training module that uses a second policy to determine second training actions for navigating the autonomous vehicle from waypoint locations between the training starting location and the training ending location to a plurality of subgoal locations; the second policy determining the second training actions without using as input sensory observations of the training scene, including any images of the training scene, except the plurality of subgoal locations and the latent representation of the training scene computed by the first policy; in determining the second training actions, the second policy producing a training loss; (iii) the representation module that backpropagates the training loss of the second training actions, for integrating into the latent representation of the training scene obstacles to avoid that are visible in the training scene between each subgoal location of each waypoint location learned by the second policy; in backpropagating the training loss, the first policy learning to avoid obstacles it detects in the latent representation of the training scene when the navigation module determines the inference actions.

In a feature, a learning method for a navigating robot includes: by a first policy, determining actions for moving the navigating robot and navigating from a starting location to an ending location based on images from a camera of the navigating robot; by a second policy, based on a representation of an environment generated by the navigating robot, determining actions for moving the navigating robot from waypoint locations between the starting location and the ending location to a plurality of subgoal locations without any images from the camera; selectively learning the representation during movement via the first policy based on the representation at previous times, images from the camera, and actions determined by the first policy at previous times; and providing the representation to the second policy.

In further features, the selectively learning the representation includes selectively learning the representation during the movement via the first policy using a neural network.

In further features, the neural network includes a recurrent neural network.

In further features, the recurrent neural network includes one of gated recurrent unit (GRU) memory and long-short term memory (LSTM).

In further features, the neural network includes one or more self-attention mechanisms.

In further features, the determining by the first policy includes, by the first policy, determining an action at a time based on the representation at the time and a goal vector at that time.

In further features, the goal vector is a Euclidean goal vector.

In further features, the plurality of subgoal locations include at least two subgoal locations from each of the waypoint locations.

In further features, each of the at least two subgoal locations of a waypoint location are within a predetermined distance range of that waypoint location.

In further features, the predetermined distance range is approximately 3 meters to approximately 5 meters.

In further features, the determining by the second policy includes, by the second policy, determining the actions for moving the navigating robot from waypoint locations between the starting location and the ending location to the plurality of subgoal locations without any images from the camera based on a recurrent neural network.

In further features, the learning method further includes, by the second policy, setting recurrent GRU memory using a GRU update function based on the representation, a previous instance of the recurrent GRU memory, and previous actions from the second policy.

In further features, the learning method further includes jointly training the second policy and the neural network using behavior cloning.

In further features, the learning method further includes jointly training the second policy and a neural network of the first policy based on minimizing an error between (a) actions predicted by the first policy during movement and (b) ground truth actions for moving.

In further features, the learning method further includes jointly training the second policy and the neural network using a cross entropy loss.

In further features, the learning method further includes, by the second policy, initializing the representation upon reaching one of the waypoint locations.

In further features, the learning method further includes, by the second policy, receiving the representation at each time step during navigation from one of the waypoint locations to one of the subgoal locations.

In further features, the learning method further includes training the first policy using one of reinforcement learning and imitation learning.

In a feature, a learning method for a navigating robot includes: by a first policy, determining actions for moving the navigating robot and navigating from a starting location to an ending location based on input from a light detection and ranging (LIDAR) sensor of the navigating robot; by a second policy, based on a representation of an environment generated by the navigating robot, determining actions for moving the navigating robot from waypoint locations between the starting location and the ending location to a plurality of subgoal locations without input from the LIDAR sensor; selectively learning the representation during movement via the first policy based on the representation at previous times, input from the LIDAR sensor, and actions determined by the first policy at previous times; and providing the representation to the second policy.

In a feature, an autonomous vehicle for navigating a scene includes: a camera for acquiring images of the scene; a navigation module comprising a first policy configured to determine inference actions for navigating the autonomous vehicle in the scene from an inference starting location to an inference ending location based on the images acquired of the scene; and one or more propulsion devices configured to implement the inference actions determined by the navigation module and propel the autonomous vehicle from the inference starting location to the inference ending location, wherein the first policy is trained by a training module that: (i) uses the first policy to determine first training actions for navigating the autonomous vehicle from a training starting location to a training ending location based on images of the scene; in determining the first training actions, the first policy receiving as input a latent representation of the scene; (ii) uses a second policy to determine second training actions for navigating the autonomous vehicle from waypoint locations between the training starting location and the training ending location to a plurality of subgoal locations; the second policy determining the second training actions without using as input sensory observations of the scene, including any images of the scene, except the plurality of subgoal locations and the latent representation of the scene computed by the first policy; in determining the second training actions, the second policy producing a training loss; (iii) backpropagates the training loss of the second training actions through the first policy, for integrating into the latent representation of the scene embedded in the first policy obstacles to avoid that are visible in the scene between each subgoal location of each waypoint location learned by the second policy; in backpropagating the training loss, the first policy learning to avoid obstacles it detects in its latent representation of the scene when the navigation module determines the inference actions.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure will become more fully understood from the detailed description and the accompanying drawings, wherein:

FIG. 1 is a functional block diagram of an example implementation of a navigating robot;

FIG. 2 is a functional block diagram of an example implementation of a control system including a control module of the navigating robot;

FIG. 3 is an example illustration of a starting location, an ending location, waypoints, and subgoal locations;

FIG. 4A is a functional block diagram of an example illustration of a navigation module;

FIG. 4B is a functional block diagram of an example illustration of a training module that implements an auxiliary policy;

FIG. 4C is a functional block diagram of an example illustration of the training module in FIG. 4B with backpropagation;

FIG. 5 is an example illustration of a navigating robot in an environment with a past path and example subgoal locations relative to its present waypoint location;

FIGS. 6-7 are example illustrations of a navigating robot in an environment with example paths and policy usage; and

FIG. 8 is a flowchart depicting an example method of learning a representation for the navigating robot.

In the drawings, reference numbers may be reused to identify similar and/or identical elements.

### DETAILED DESCRIPTION

Visual navigation of mobile robots combines the domains of vision and control. Navigation can be described as finding a suitable and non-obstructed path between a starting location and a destination location. A navigating robot includes a control module configured to move the navigating robot based on input from one or more sensors (e.g., cameras, light detection and ranging (LIDAR), etc.).

Agents (e.g., navigating robots) navigating in three dimensional (3D) environments include memory, which includes a compact and actionable representation of the history of observations useful for decision taking and planning for navigating the 3D environment. In end-to-end learning approaches the representation is latent and usually does not have a clearly defined interpretation. Other implementations involve scene reconstruction resulting in some form of map, such as estimated with geometry and sensor models and/or learning.

The present application involves learning an actionable representation of a 3D space independently of a targeted downstream task and without explicitly optimizing reconstruction. The learned representation is optimized by a blind agent trained to navigate with it on multiple short sub episodes branching out from one or more waypoints along a path and, most importantly, without any direct visual observation (e.g., camera images). The non-use of visual observations while navigating the branches is what may be referred to as blind navigation (blind agent).

The blindness of the agent during navigation of the branches forces the (trained) latent representation to be the only means for path planning. The learned representation optimizes navigability and not reconstruction. On downstream tasks, the learned representation is robust to changes in distribution, in particular the simulation to real world space gap.

As stated above, navigation in 3D environments involves an agent building an actionable representation of the 3D environment. The present application involves use of tailored auxiliary losses, which are based on interactions with the environment and directly target the property of generating a latent representation: its usability for navigation. The present application avoids spending training signals on learning to explicitly reconstruct the 3D space in unnecessary detail, which may not be useful for downstream tasks and may harm transfer. The present application may augment the amount of information carried by the training signal compared to rewards. Performing local navigation by a navigating robot, the capability to detect free navigable space, is important to navigating robots to avoid obstacles and to find the openings (e.g., of doors) in closed spaces in order to leave them and enter other spaces. The present application involves a training module learning a representation which optimizes these skills directly, prioritizing usability over fidelity. A representation is built by the learning module based on a sequential integration of visual observations (e.g., based on images from a camera of the navigating robot). This representation is passed to a blind auxiliary agent, which is trained to use it as its sole information to navigate to a batch of intermediate points that branch from waypoints.

Optimizing over the success of the blind auxiliary agent generates an actionable representation and can be done independently of the downstream task.

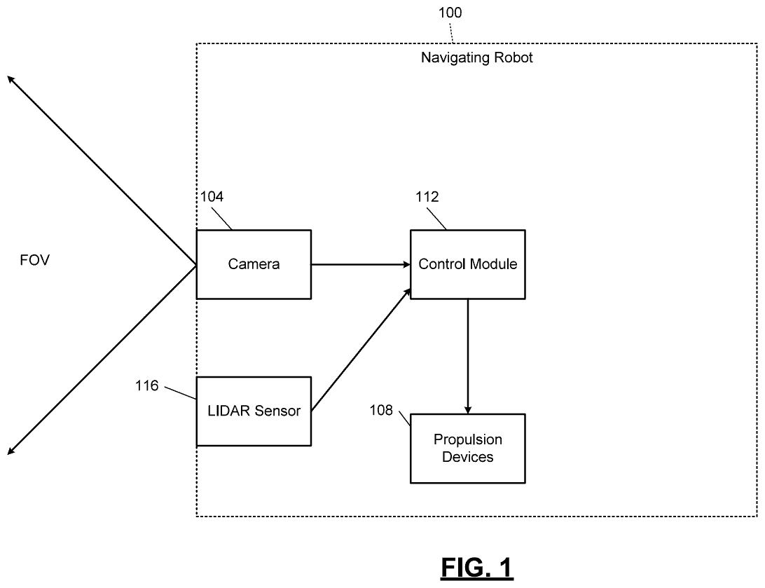

FIG. 1 is a functional block diagram of an example implementation of a navigating robot 100. The navigating robot 100 is a mobile vehicle. The navigating robot 100 includes a camera 104 that captures images within a predetermined field of view (FOV) in front of the navigating robot 100. The operating environment of the navigating robot 100 may be an indoor space or an outdoor space. In various implementations, the navigating robot 100 may include multiple cameras and/or one or more other types of sensing devices (e.g., LIDAR, radar, etc.).

The camera 104 may be, for example, a grayscale camera, a red, green, blue (RGB) camera, or another suitable type of camera. In various implementations, the camera 104 may also capture depth (D) information, such as in the example of a grayscale-D camera or a RGB-D camera. The camera 104 may be fixed to the navigating robot 100 such that the orientation and FOV of the camera 104 relative to the navigating robot 100 remains constant.

The navigating robot 100 includes one or more propulsion devices 108, such as one or more wheels, one or more treads/tracks, one or more moving legs, one or more propellers, and/or one or more other types of devices configured to propel the navigating robot 100 forward, backward, right, left, up, and/or down. One or a combination of two or more of the propulsion devices 108 may be used to propel the navigating robot 100 forward or backward, to turn the navigating robot 100 right, to turn the navigating robot 100 left, and/or to elevate the navigating robot 100 vertically upwardly or downwardly.

The camera 104 may update (capture an image) at a predetermined frequency, such as 60 hertz (Hz), 120 Hz, or another suitable frequency. The control module 112 may update a labeled map (discussed further below) each time the input from the camera 104 is updated. The navigating robot 100 may also include a light detection and ranging (LIDAR) sensor 116. In various implementations, one of the LIDAR sensor 116 and the camera 104 may be omitted.

A control module 112 is configured to control the propulsion devices 108 to navigate a space (e.g., an indoor real world space or simulated space) using a map or a representation of the space.

In various implementations, each time step, the control module 112 may determine an action to be taken by the navigating robot 100 to navigate the space toward or to a goal location without contacting any objects in the space. For example, the control module 112 may actuate the propulsion devices 108 to move the navigating robot 100 forward by a predetermined distance under some circumstances. The control module 112 may actuate the propulsion devices 108 to move the navigating robot 100 backward by a predetermined distance under some circumstances. The control module 112 may actuate the propulsion devices 108 to turn the navigating robot 100 to the right by the predetermined angle under some circumstances. The control module 112 may actuate the propulsion devices 108 to turn the navigating robot 100 to the left by the predetermined angle under some circumstances. The control module 112 may not actuate the propulsion devices 108 to not move the navigating robot 100 under some circumstances. The control module 112 may actuate the propulsion devices 108 to move the navigating robot 100 upward under some circumstances. The control module 112 may actuate the propulsion devices 108 to move the navigating robot 100 downward under some circumstances. The control module 112 may actuate the propulsion devices 108 to avoid the navigating robot 100 contacting any objects or walls of the space. In various implementations, the control module 112 may actuate the propulsion devices 108 to move in two or more directions at the same time. The control module 112 may also determine velocity commands, such as linear velocity and/or angular velocity and determine motor speed(s) based on the velocity command(s). In various implementations, the control module 112 may directly determine the motor speed(s).

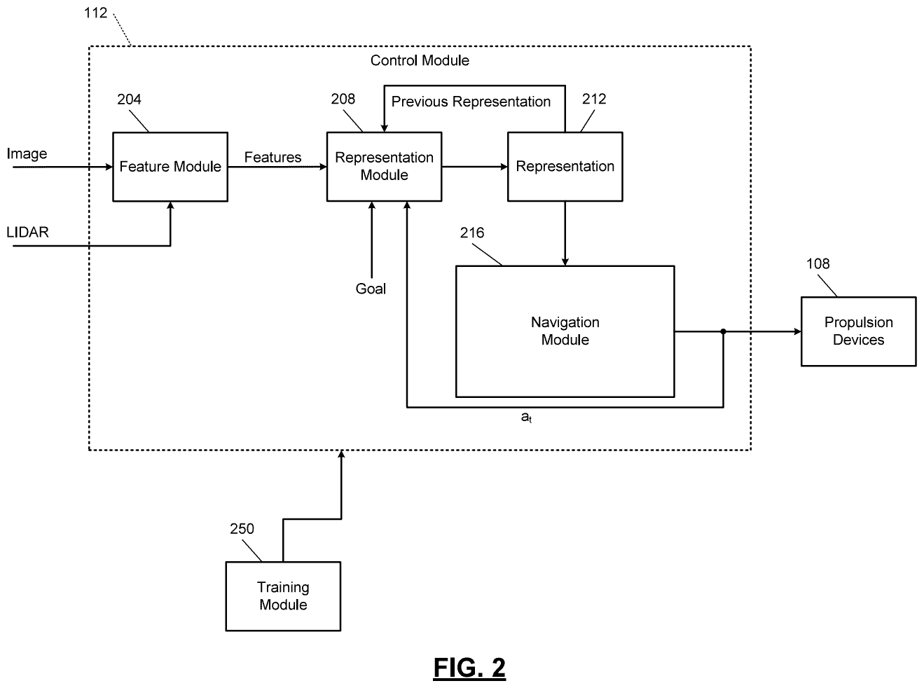

FIG. 2 is a functional block diagram of an example implementation of a control system including the control module 112.

Referring to FIG. 2, a feature module 204 receives images and extracts features from the images. The images may be from the camera 104 during real world use (including during evaluation) or from a simulated environment during training. Additionally or alternatively, the feature module 204 may receive the LIDAR input and extracts features from the LIDAR input. The features may be, for example, vectors, matrices, etc. The LIDAR input may be from the LIDAR sensor 116 during real world use (including during evaluation) or simulated during training. The features may be referred to as observations oₜ.

A representation module 208 generates a map or representation 212 of the space in which the navigating robot 100 is located in some instances using the features as discussed further below. In other instances (e.g., during navigation of branches from waypoints), the representation module 208 generates the representation 212 blindly-independently of the images, LIDAR input, and input from one or more other types of visual sensors (e.g., radar, sonar, etc.).

In various implementations, the LIDAR input may be used with the motor commands predicted by the navigation module 216. For example, if the navigation module 216 determined to move forward by the predetermined distance, the navigation module may use the LIDAR input to move the robot forward until predetermined distance is moved. Then control may be is given back to the agents described herein. In various implementations, the LIDAR input may not be used for this purpose and another suitable form of odometry may be used, such as one or more wheel encoders, inertial units, etc.

A navigation module 216 controls the propulsion devices 108 to navigate the space using the representation 212. For example, the navigation module 216 may control the propulsion devices 108 to navigate the space from a present location to a target/goal location in the space using the representation 212. The goal location may be received via user input. The navigation module 216 may track the present location of the navigating robot 100 using signals from one or more sensors of the navigating robot 100 and/or triangulation via wireless signals. To navigate from the present location to the goal location, the navigation module 216 may determine a path from the present location to the goal location using a planner algorithm. If the path is longer than a predetermined length, the path may include one or more waypoint locations along the path.

The representation 212 is a (e.g., vector, matrix, etc.) representation which can be useful for different visual navigation problems, and without loss of generality, the present application will be described as it relates to the PointGoal task of navigating from a present location to a goal location. The navigation module 216 receives visual observations oₜ and a Euclidean goal vector G at each time step t and selects an action at. As described above, the action may be selected from a set of discrete actions. Example actions are which are move forward a predetermined distance (e.g., 25 centimeters), turn left a predetermined angle (e.g., 10 degrees), turn right a predetermined angle (e.g., 10 degrees), or stop/stay in the same location.

The representation module (an agent) 208 sequentially builds a representation rₜ (the representation 212) from the time series of observations {o_{t′}}_{t′<t} and the previous action from the last time step (aₜ₋₁). A policy π of the navigation module 216 determines a distribution over actions (p(aₜ)), using the representation rₜ such as follows

$${r}_{t} = f ( {o}_{t} , {r}_{t - 1} , {a}_{t - 1} ) \qquad ( 1 )$$

$$p ( {a}_{t} ) = π ( {r}_{t} , G ) \qquad ( 2 )$$

where f is a neural network with gated recurrent unit (GRU) memory, or a long-short term memory (LSTM) or another suitable type of recurrent neural network, or which can be modeled as self-attention over time. Herein, dependencies on parameters and gating mechanisms may be omitted from notations. The policy may select the action with the highest probability.

The present application does not focus on learning the policy π. The policy may be trained by a training module using reinforcement (RL), imitation learning (IL), or in another suitable manner a given downstream task. Instead of the policy, the present application involves the representation module 208 learning the representation rₜ through its usefulness. The representation module 208 optimizes the amount of information the representation rₜ carries about the navigability of (and towards) different parts of the space. When given to a blind auxiliary agent (i.e., the navigation module 216 without receiving visual observations, such as images from a camera of a navigating robot), the representation rₜ allows the (blind) navigation module 216 to navigate sufficiently close to locations (points) without requiring any visual observation.

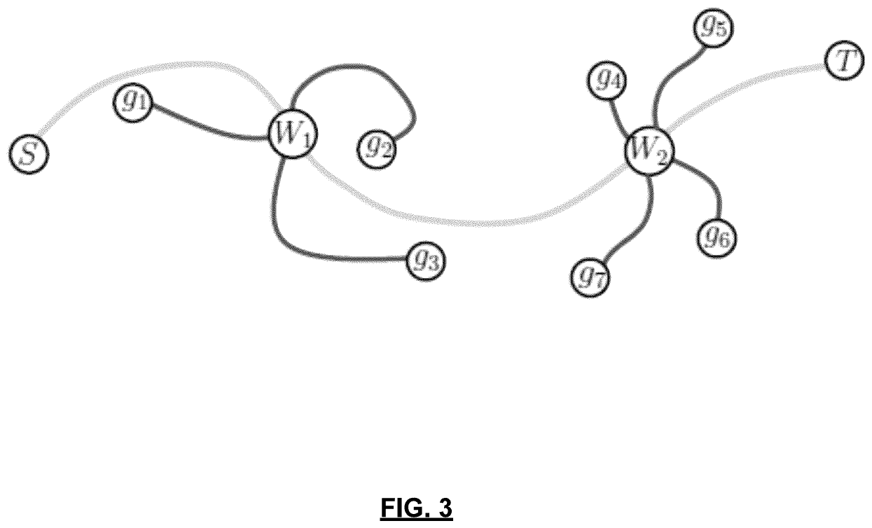

Training data input for the representation module 208 to learn the representation rₜ may be divided into episodes, for each of which there is an optimal (e.g., shortest) path from a present location to a goal location for the episode. FIG. 3 is an example illustration of a long episode (longer than a predetermined distance) between start location S and target location T and short episodes that branch from waypoint locations W₁ and W₂ between locations S and T. The navigation module 216 follows the long episodes using the policy π. The representation module 208 integrates the observations oₜ into representations rₜ using equation (1) above.

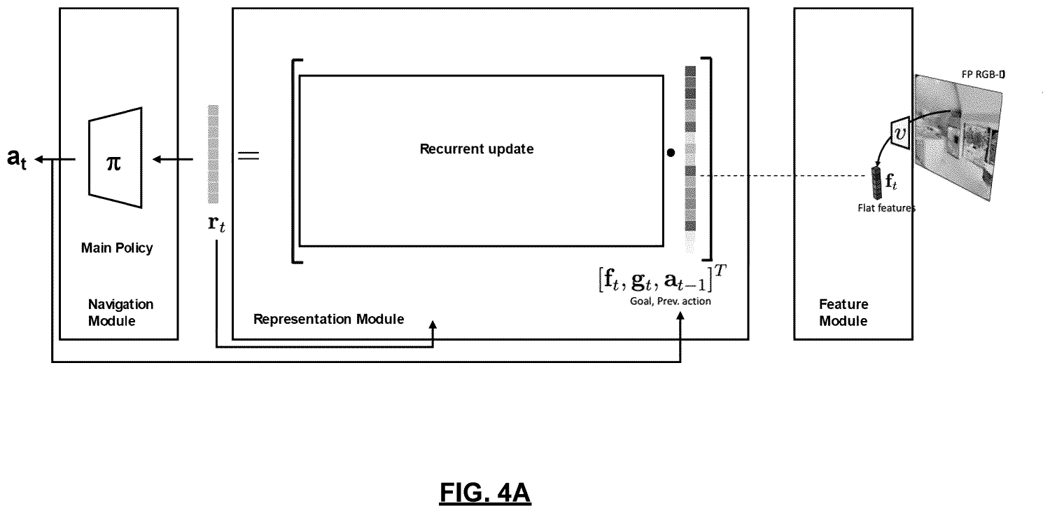

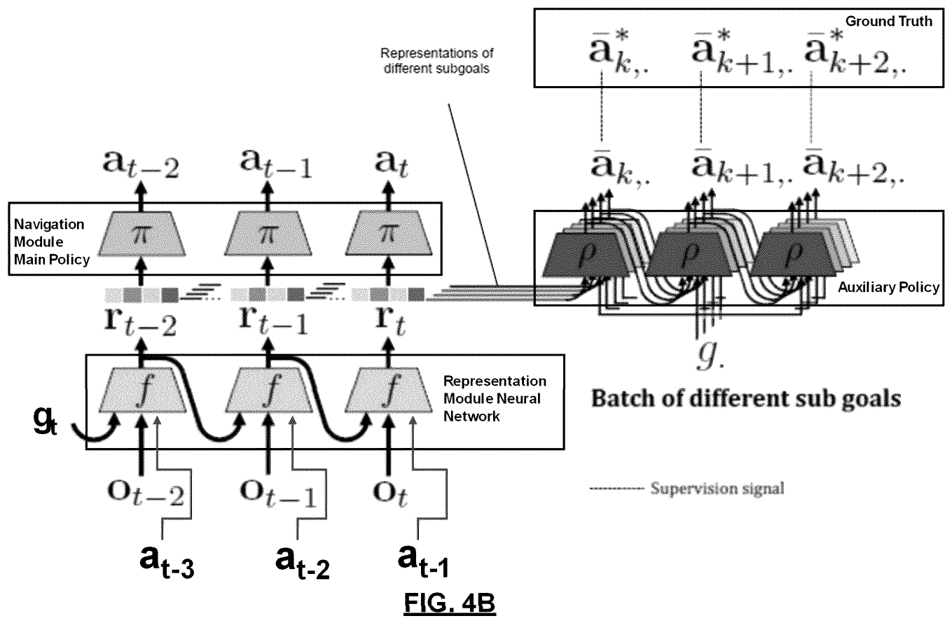

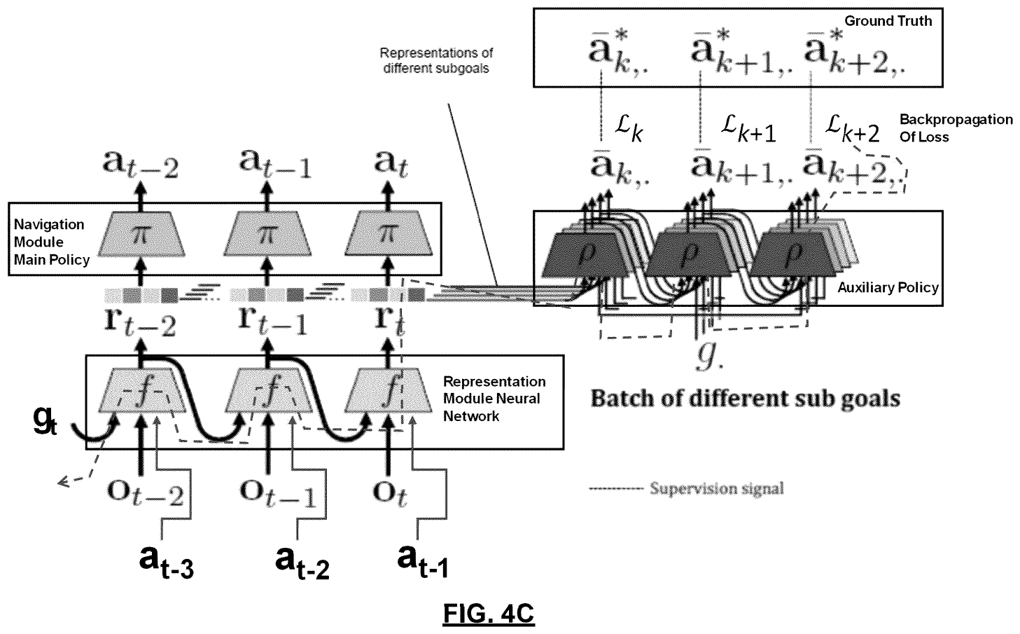

Waypoints Wᵢ may be sampled along the long episode, such as separated by a predetermined distance. At the waypoints Wᵢ, representations rₜ are collected by the navigation module 216 and communicated to a batch (of size B) of multiple blind auxiliary agents of the navigation module 216, which branch out at the waypoint and are trained to navigate to a corresponding batch of subgoals (short episodes) {gⱼ}_{j=1 . . . B}. The blind agents navigate using an auxiliary policy ρ which may operate using its own GRU memory h such as follows:

$${h}_{k , j} = \overline{f} ( {h}_{k - 1 , j} , {r}_{t} , {g}_{j} , {\overline{a}}_{k - 1 , j} ) and \qquad ( 3 )$$

$$p ( {\overline{a}}_{k , j} ) = ρ ( {h}_{k , j} ) \qquad ( 4 )$$

where the index j is over the subgoals of the batch, k goes over the steps of the short episode, and the actions α̅_{k-1,j} are actions produced by the auxiliary policy of the navigation module 216. The representation rₜ collected at step t of the main policy π remains constant over the steps k of the auxiliary policy (during navigation to the subgoals via the branches from the waypoints), with f̅ being GRU update function. This is illustrated by the example block diagram of FIG. 4B. In the example of FIG. 4B, α̅ₖ* are optimal actions to achieve an optimal (e.g., shortest) path. f̅ is not shown and is integrated into ρ. As illustrated by FIGS. 4A-4C, the auxiliary policy is only used for training and not during inference. The recurrent network in FIG. 4A is not unrolled, whereas it is unrolled in FIGS. 4B and 4C. FIG. 4C shows backpropagation through the auxiliary policy and the representation module's neural network.

A training module 250 may train the auxiliary policy ρ and f based on using the representation rₜ minimizing the error between actions generated α̅ₗ*, and ground truth (GT) actions α̅ₗ* stored in memory for optimal (e.g., shortest) path, such as using the equation

$$\hat{f} = arg {min}_{f , ρ} {\sum }_{k} {\sum }_{j = 1}^{B} {ℒ}_{CE} ( {\overline{a}}_{k , j} , {\overline{a}}_{k , j}^{*} ) \qquad ( 5 )$$

where [symbol] _{CE} is a cross-entropy loss and index k runs over all steps during the training. In what follows, loss (5) will be denoted as [symbol] _{Nav}. While the loss runs over the steps k in the short (blind) episodes, these steps are attached to the steps t in long episodes through the visual representation π generated by the encoder f as in equation (4). The auxiliary policy ρ is not used after training. Navigation is performed by the policy π which is trained by the training module 250 as discussed above and on its own downstream objective. Optionally, the main policy π can also be trained jointly with auxiliary policy ρ, for instance with Behavior Cloning (BC), such as based on minimizing the difference between the actions predicted by the main (non-blind) policy with ground truth actions, denoted in what follows as [symbol] _{BC}.

Regarding the subgoals, for a given computational budget, there is a balance between how many steps are used for long episodes versus how many steps are used for short episodes as each step spent on a short episode is removing one visual observation from training—auxiliary policy ρ is blind.

A fixed predetermined number of subgoals may be used at each waypoint and have a predetermined Euclidean distance from the waypoint. Choosing subgoal positions well may increase performance. If they are too close to the waypoint, they may lack information. If they are outside of the area observed previously during the episode by the agent (and thus not represented in rₜ), the navigation module 216 may rely on regularities in environment layouts to navigate during the blind operation and not rₜ.

During the training, a rollout buffer may collect multiple parallel environment interactions, on which the loss is trained. This may facilitate optional batching of proximal policy optimization (PPO), with losses being separated over different environments.

The training module 250 may perform the training in two phases. The first phase may be a representation training where the training module 250 jointly trains the representation rₜ, and the auxiliary agent ρ based on minimizing the loss of equation (5) above, optionally also jointly the policy π with a BC loss. The second phase may be fine-tuning where the training module 250 performs fine-tune training on the downstream task, for instance using a reinforcement learning objective like PPO, or other losses. As already mentioned, a combination of losses may be used, a navigability loss ( [symbol] _{Nav}) and a behavior cloning (BC) loss ( [symbol] _{BC}), [symbol] = [symbol] _{Nav}+ [symbol] _{BC}. The advantages of this joint strategy may be two-fold: (i) training the main policy is not idle for environments selected for the navigability loss, and (ii) visual observations gathered in environment steps spent in short episodes are not wasted, as they are used for training rₜ through backpropagation through the policy π. ρ and π may be used to represent both aux policy and policy as well as aux agent and agent.

Blindness of the auxiliary agent provides better performance. A non-blind auxiliary agent would be similar to classical BC.

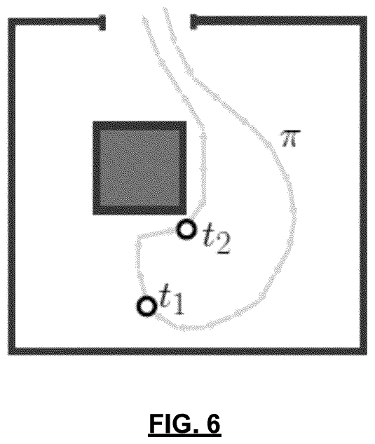

To illustrate the advantage of the blindness property of the auxiliary agent, an example scenario is considered. FIG. 6 illustrates an agent π which, after having entered the scene (room) and made a circular motion, has observed the central square-shaped obstacle and the presence of the door it came through. A goal is to maximize the amount of information on the obstacles and navigable space extracted by the agent through its training objective. The representation estimated at the waypoint t=t₁, should be present in the observation history {ot} t≤ t1, but there is no guarantee that it will be kept in the representation rₜ at t=t₁, as the amount of information storable in the recurrent memory rₜ is lower than the information observed during the episode. Agent training leads to a learned compression mechanism, where minimizing the navigation loss, such as through RL or BC, compresses {oₜ} t≤t₁ in two steps: (1) information from oₜ not useful at all is discarded by f before it is integrated into rₜ; (2) information from oₜ useful for a single step is integrated into rₜ, used by π and then discarded by f at the next update and therefore does not make it into rₜ₊₁. The information content in r may mean the mutual information (MI) between rₜ and the observation history, i.e.

$$I ( {r}_{t} ; {o}_{past} ) = {p ( {o}_{past} )}_{} [ log \frac{p ( {r}_{t} \vert {o}_{past} )}{p ( {r}_{t} )} ] \qquad ( 9 )$$

where oₚₐₛₜ={oₜ}_{t′st}. The BC objective may be insufficient to retain information on the scene structure observed before t=t₁ in rₜ at t=t₁. Generally, consider the learning signal at t=t₂, where t₂>t₁, as in FIG. 6. It is assumed that the agent predicts an action at which would lead to a collision with the central obstacle, and receives a supervision ground truth signal αₜ*, which avoids the collision, Minimizing [symbol] (αₜ, αₜ*) involves learning to predict the correct action αₜ* given its input rₜ, and in this case this can happen in two different reasoning modes: (r1) involves learning a policy which avoids obstacles visible in its current observation, which can be achieved by a reactive (memory-less) agent, or (r2) learning a policy which avoids obstacles it detects in its internal latent map, which was integrated over its history of observations. The present application involves the improvement of (r2), which is the desired objective of an intelligent agent.

However, if minimizing the BC objective can be realized by both (r1) and (r2) training (without this application) may prioritize learning (r1) and neglect (r2) for essentially two reasons: firstly, the compression mechanism favors (r1) which does not require holding it in an internal state for longer than one step. Secondly, reasoning (r2) happens over multiple hops and involves the exploitation of error gradient backpropagation over multiple time instants for the integration of the observed sequence into a usable latent map. The vanishing gradient problem may make learning (r2) harder than the short chain reasoning (r1).

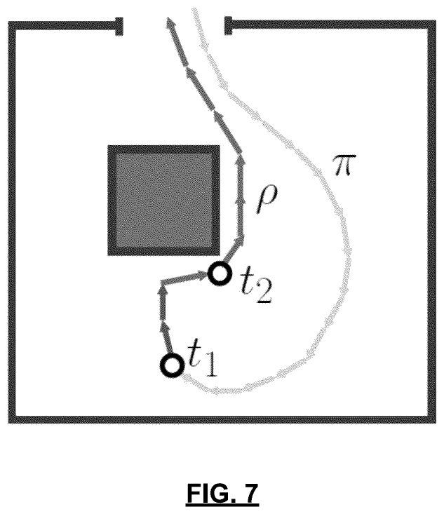

FIG. 7 illustrates the same scenario as FIG. 6 involving the proposed navigability loss. The main agent π integrates visual observations over its own (lighter colored) trajectory up to waypoint t=t₁. The aux agent ρ navigates on the blue trajectory. Consider again the effect of the supervised learning signal at the later instant t=t₂. Again minimizing [symbol] (αₜ,αₜ*) involves learning an agent configured to predict the correct αₜ* given its input rₜ, but now, this can happen in one way only: since the agent ρ is blind (i.e., not using visual observations), the BC objective cannot lead to reasoning (r1), i.e. memoryless, as it lacks the necessary visual observation to do so. The only way that the agent can consistently predict the correct action at is through the representation n collected at time t=t₁, i.e. (r2). Making the auxiliary agent blind has thus the double effect of resisting the compression mechanism in learning, and to force the learning signal through a longer backpropagation chain, both of which help integrating relevant observations into the agent memory.

For the reasons developed above, the concepts described herein are different from data augmentation (DA): the steps on short episodes improve the representation integrated over visual observations on long episodes, whereas DA would generate new samples and train them with the same loss. The steps on short episodes described herein can be seen as generating a new learning signal for existing samples on long episodes using privileged information from a training environment (e.g., simulator).

Sequentially integrating visual information over time (r2) increases robustness compared to taking decisions from individual observations (r1), in particular in the presence of simulation to real world gaps. Reactive reasoning (r1) may lead to more likely exploitation of spurious correlations in simulation then mapping (r2).

In various implementations, waypoints may be set to a predetermined distance, such as every approximately 3 meters or another suitable distance. The distance for the subgoals from its waypoint may be between 3 and 5 meters or another suitable distance. The threshold for removing unhelpful subgoals may be T=approximately 1.5 meters or another suitable distance. The training may involve, for example, 100 million environment steps (interactions with the environment) or another suitable number of steps. The pretraining may involve one half of the steps, such as approximately 50 million steps or another suitable number of steps. The pretraining may involve PPO, BC, and learning based on minimizing the navigability loss. The fine tuning portion of the training may involve the remainder of the steps. The fine tune training may be performed with PPO on the downstream point goal task of navigating from a starting location to an ending location, or another suitable navigation loss.

As discussed above, during the representation learning phase (first phase), the agent π communicates the representation (an embedding) rₜ to the blind agent ρ. The representation remains constant during the k steps of an individual short episode. In various implementations, the auxiliary (blind) agent ρ perceives the representation rₜ as input at each step. In other implementations, the hidden GRU state h of the blind agent ρ is initialized as the representation rₜ at the beginning of each short episode and no visual observation other than the subgoal location g is input to the blind agent ρ. Providing the representation rₜ as the initialization for the hidden GRU state may allow for evolution and updating by the blind agent ρ during the navigation to each subgoal. In various implementations, 128 dimensions or another suitable number of dimensions may be added to the blind agent hidden state h.

The present application provides a new auxiliary loss and agent for representation learning and builds a latent visual representation from interactions of the blind agent with the environment. The learned representation is robust to domain shifts.

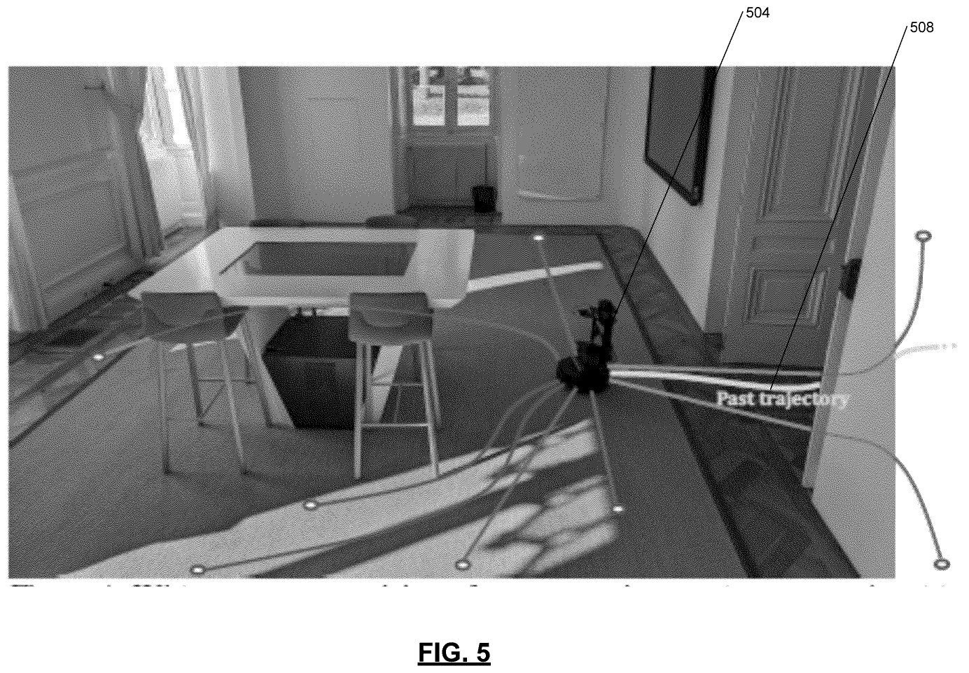

FIG. 5 is an example image of a navigating robot 504 (i.e., agent) in a real world environment. Lighter colored trace 508 tracks its previous trajectory to the present location which is a waypoint. The blue traces lead to subgoal locations denoted as circles to which the blind agent navigates. An actionable map like representation is learned by the agent by integration of visual observations collected along the previous trajectory 508. The representation learned at the given waypoint shown is passed to the blind auxiliary agent, which navigates to the subgoal locations without visual observations (blindly). The training module 250 updates the representation based on success of the blind agent blindly navigating to the subgoals. Once a predetermined number of episodes have been completed, the representation can be used in the real world by navigating robots to navigate real world spaces.

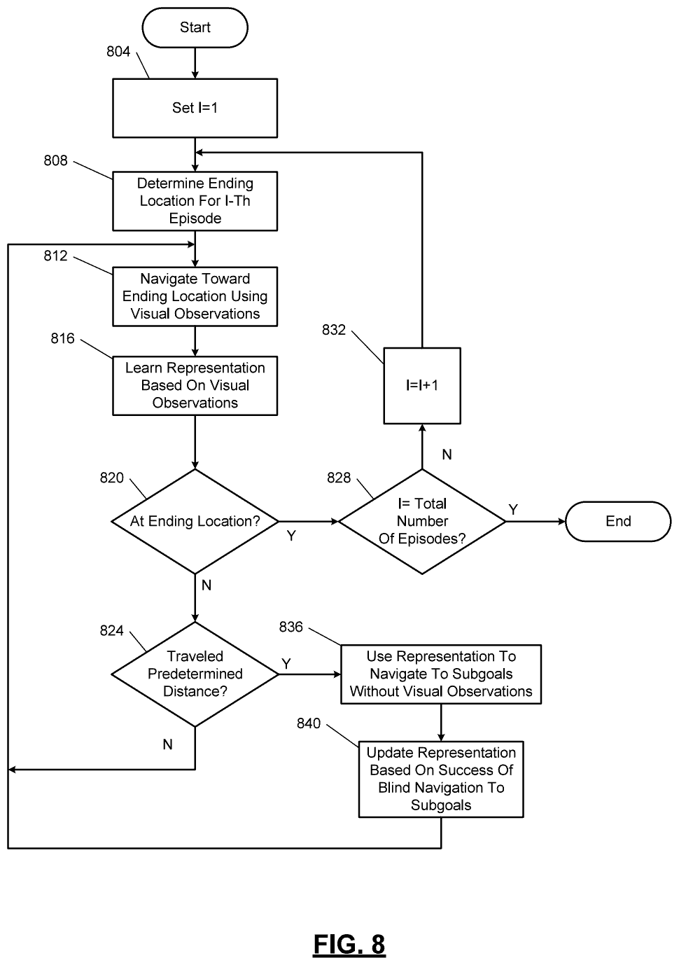

FIG. 8 is a flowchart depicting an example method of learning the representation. Control begins with 804 where the navigation module 216 sets a counter value I to 1. At 808 the navigation module 216 determines the ending location of the robot for the I-th episode. At 812, the navigation module 216 actuates one or more of the propulsion devices 108 using one or more visual observations (e.g., based on one or more images from the camera) using the agent π to move the navigating robot toward the ending location. At 816, the representation module 218 updates the representation 212 based on one or more of the visual observations.

At 820, the navigation module 216 determines whether the present location of the navigating robot is at the ending location of the I-th episode. If 820 is true, control continues with 828. If 820 is false, control may continue with 824.

At 824, the navigation module 216 determines whether the navigating robot has moved a predetermined distance from a last waypoint or its starting location. If 824 is true, control continues with 836. At 836, the navigation module 216 using the auxiliary policies p blindly navigates to subgoals using the representation without visual observations (e.g., without using any images from the camera). The representation may be held constant during the blind navigation. In various implementations, blind agent performs multiple steps towards the sub goal and the representation is updated at each of its steps based on the loss between the action predicted by the blind agent and the ground truth (expected) action. As discussed above, there are multiple blind agents per main agent dispatched to multiple subgoals.

At 840, the representation module 208 may update the representation based on whether or not the blind agent predicted the correct expert action: the training module 250 may train the auxiliary agents ρ and the function f used to predict the representation jointly using BC based on minimizing an error between actions determined by the auxiliary agents ρ and the stored ground truth actions for following shortest paths. Control returns to 812.

At 828, the navigation module 216 may determine whether I is equal to a predetermined total number of episodes to be completed. If 828 is true, control may end. If 828 is false, the navigation module 216 may increment the counter value I (e.g., set I=I+1) at 832 and control may return to 808.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A learning system for an autonomous vehicle, comprising:
a navigation module comprising:
a first policy configured to determine first actions for navigating the autonomous vehicle from a starting location to an ending location in a scene based on a latent representation of the scene; and
a training module comprising:
a second policy configured to determine second actions for navigating the autonomous vehicle from waypoint locations between the starting location and the ending location to a plurality of subgoal locations; the second policy determining the second actions without using as input sensory observations of the scene, including any images of the scene, except the plurality of subgoal locations and the latent representation of the scene computed by the first policy; in determining the second actions, the second policy producing a loss; and
a representation module configured to:
generate, as input to the first and second policies, the latent representation of the scene from images of the scene;
backpropagate the loss of the second actions, for integrating into the latent representation of the scene obstacles to avoid that are visible in the scene between each subgoal location of each waypoint location learned by the second policy; in backpropagating the loss, the first policy learning to avoid obstacles it detects in the latent representation of the scene when the navigation module determines inference actions.

2. The learning system of claim 1 wherein the representation module is configured to selectively learn the representation during the movement via the first policy using a neural network.

3. The learning system of claim 2 wherein the neural network includes a recurrent neural network.

4. The learning system of claim 2 wherein the recurrent neural network includes one of gated recurrent unit (GRU) memory and long-short term memory (LSTM).

5. The learning system of claim 2 wherein the neural network includes one or more self-attention mechanisms.

6. The learning system of claim 1 wherein the first policy is configured to determine an action at a time based on the representation at the time and a goal vector at that time.

7. The learning system of claim 6 wherein the goal vector is a Euclidean goal vector.

8. The learning system of claim 1 wherein the plurality of subgoal locations include at least two subgoal locations from each of the waypoint locations.

9. The learning system of claim 8 wherein each of the at least two subgoal locations of a waypoint location are within a predetermined distance range of that waypoint location.

10. The learning system of claim 9 wherein the predetermined distance range is approximately 3 meters to approximately 5 meters.

11. The learning system of claim 1 wherein the second policy is configured to determine the actions for moving the navigating robot from waypoint locations between the starting location and the ending location to the plurality of subgoal locations without any images from the camera based on a recurrent neural network.

12. The learning system of claim 11 wherein the second policy is configured to set the recurrent GRU memory using a GRU update function based on the representation, a previous instance of the recurrent GRU memory, and previous actions from the second policy.

13. The learning system of claim 1 further comprising a training module is configured jointly train the second policy and the neural network using behavior cloning.

14. The learning system of claim 13 wherein the training module is configured to jointly train the second policy and a neural network of the first policy based on minimizing an error between (a) actions predicted by the first policy during movement and (b) ground truth actions for moving.

15. The learning system of claim 12 wherein the training module is configured to jointly train the second policy and the neural network using a cross entropy loss.

16. The learning system of claim 11 wherein the second policy is configured to initialize the representation upon reaching one of the waypoint locations.

17. The learning system of claim 11 wherein the second policy is configured to receive the representation at each time step during navigation from one of the waypoint locations to one of the subgoal locations.

18. The learning system of claim 1 further comprising a training module configured to train the first policy using one of reinforcement learning and imitation learning.

19. A learning system for a navigating robot, comprising:
a navigation module comprising:
a first policy configured to determine actions for moving the navigating robot and navigating from a starting location to an ending location based on input from a light detection and ranging (LIDAR) sensor of the navigating robot; and
a second policy configured to, based on a representation of an environment generated by the navigating robot, determine actions for moving the navigating robot from waypoint locations between the starting location and the ending location to a plurality of subgoal locations without input from the LIDAR sensor; and
a representation module configured to:
selectively learn the representation during movement via the first policy based on the representation at previous times, input from the LIDAR sensor, and actions determined by the first policy at previous times; and
provide the representation to the second policy.

20. An autonomous vehicle for navigating a scene, comprising:
(a) a camera for acquiring images of the scene;
(b) a representation module for generating a latent representation of the scene from images of the scene;
(c) a navigation module comprising a first policy configured to determine inference actions for navigating the autonomous vehicle in the scene from an inference starting location to an inference ending location based on the latent representation of the scene; and
(d) one or more propulsion devices configured to implement the inference actions determined by the navigation module and propel the autonomous vehicle from the inference starting location to the inference ending location;
wherein the first policy is trained by:
(i) the navigation module that uses the first policy to determine first training actions for navigating the autonomous vehicle from a training starting location to a training ending location based on a latent representation of a training scene received from a representation module generated from images of the training scene;
(ii) a training module that uses a second policy to determine second training actions for navigating the autonomous vehicle from waypoint locations between the training starting location and the training ending location to a plurality of subgoal locations; the second policy determining the second training actions without using as input sensory observations of the training scene, including any images of the training scene, except the plurality of subgoal locations and the latent representation of the training scene computed by the first policy; in determining the second training actions, the second policy producing a training loss;
(iii) the representation module that backpropagates the training loss of the second training actions, for integrating into the latent representation of the training scene obstacles to avoid that are visible in the training scene between each subgoal location of each waypoint location learned by the second policy; in backpropagating the training loss, the first policy learning to avoid obstacles it detects in the latent representation of the training scene when the navigation module determines the inference actions.

21. A learning method for a navigating robot, comprising:
by a first policy, determining actions for moving the navigating robot and navigating from a starting location to an ending location based on images from a camera of the navigating robot;
by a second policy, based on a representation of an environment generated by the navigating robot, determining actions for moving the navigating robot from waypoint locations between the starting location and the ending location to a plurality of subgoal locations without any images from the camera;
selectively learning the representation during movement via the first policy based on the representation at previous times, images from the camera, and actions determined by the first policy at previous times; and
providing the representation to the second policy.

22. The learning method of claim 21 further comprising selectively learning the representation during the movement via the first policy using a neural network.

23. The learning method of claim 22 wherein the neural network includes a recurrent neural network.

24. The learning method of claim 22 wherein the recurrent neural network includes one of gated recurrent unit (GRU) memory and long-short term memory (LSTM).

25. The learning method of claim 22 wherein the neural network includes one or more self-attention mechanisms.

26. The learning method of claim 21 wherein the determining by the first policy includes, by the first policy, determining an action at a time based on the representation at the time and a goal vector at that time.

27. The learning method of claim 26 wherein the goal vector is a Euclidean goal vector.

28. The learning method of claim 21 wherein the plurality of subgoal locations include at least two subgoal locations from each of the waypoint locations.

29. The learning method of claim 28 wherein each of the at least two subgoal locations of a waypoint location are within a predetermined distance range of that waypoint location.

30. The learning method of claim 29 wherein the predetermined distance range is approximately 3 meters to approximately 5 meters.

31. The learning method of claim 21 wherein the determining by the second policy includes, by the second policy, determining the actions for moving the navigating robot from waypoint locations between the starting location and the ending location to the plurality of subgoal locations without any images from the camera based on a recurrent neural network.

32. The learning method of claim 31 further comprising, by the second policy, setting recurrent GRU memory using a GRU update function based on the representation, a previous instance of the recurrent GRU memory, and previous actions from the second policy.

33. The learning method of claim 21 further comprising jointly training the second policy and the neural network using behavior cloning.

34. The learning method of claim 33 further comprising jointly training the second policy and a neural network of the first policy based on minimizing an error between (a) actions predicted by the first policy during movement and (b) ground truth actions for moving.

35. The learning method of claim 32 further comprising jointly training the second policy and the neural network using a cross entropy loss.

36. The learning method of claim 31 further comprising, by the second policy, initializing the representation upon reaching one of the waypoint locations.

37. The learning method of claim 31 further comprising, by the second policy, receiving the representation at each time step during navigation from one of the waypoint locations to one of the subgoal locations.

38. The learning method of claim 21 further comprising training the first policy using one of reinforcement learning and imitation learning.

39. A learning method for a navigating robot, comprising:
by a first policy, determining actions for moving the navigating robot and navigating from a starting location to an ending location based on input from a light detection and ranging (LIDAR) sensor of the navigating robot;
by a second policy, based on a representation of an environment generated by the navigating robot, determining actions for moving the navigating robot from waypoint locations between the starting location and the ending location to a plurality of subgoal locations without input from the LIDAR sensor;
selectively learning the representation during movement via the first policy based on the representation at previous times, input from the LIDAR sensor, and actions determined by the first policy at previous times; and
providing the representation to the second policy.
